(19) United States
(12) Patent Application Publication
(10) Pub. No.: US 2013/0286426 A1
(43) Pub. Date: Oct. 31, 2013

(54) PRINTER MANAGEMENT

(71) Applicants: Peter Morovic, Barcelonia (ES); Jan Morovic, Colchester Essex (GB)

(72) Inventors: Peter Morovic, Barcelonia (ES); Jan Morovic, Colchester Essex (GB)

(21) Appl. No.: 13/459,652

(22) Filed: Apr. 30, 2012

(51) Int. Cl. G06K 15/02

(52) U.S. Cl. 358/1.14

(57) ABSTRACT

A request for printing or print-management is received at a centralized location. Access rights related to the request are determined. A printer associated with the access rights is displayed. Printing on or print-management for the printer is permitted according to the access rights.

### BACKGROUND

Different types of printer devices can be accessed for printer management (for printer control and printing) in different ways. The different access mechanisms for the different printer devices provide different user experiences and different levels of control through different underlying technologies. A common thread between the different access mechanisms is the need for a direct connection to the different printer devices. The connection can be a wired connection or a wireless connection; however, the connection needs to be established before the different access mechanisms can facilitate access to the printer device and control of the printer device.

### BRIEF DESCRIPTION OF THE DRAWINGS

Non-limiting and non-exhaustive implementations of the subject disclosure are described with reference to the following figures, wherein like reference numerals refer to like parts throughout the various views unless otherwise specified.

FIG. 1 is a schematic block diagram of a server that facilitates remote printer management, according to an implementation of the subject disclosure.

FIG. 2 is a schematic block diagram of a system that facilitates remote printer management in a cloud computing environment, according to an implementation of the subject disclosure.

FIG. 3 is a schematic block diagram of an example login screen of a print management dashboard, according to an implementation of the subject disclosure.

FIG. 4 is a schematic block diagram of an example printer management screen of a print management dashboard, according to an implementation of the subject disclosure.

FIG. 5 is a schematic block diagram of an example printer modification screen of a print management dashboard, according to an embodiment of the subject disclosure.

FIG. 6 is a schematic process flow diagram of a method for remote printer management, according to an implementation of the subject disclosure.

FIG. 7 is a schematic process flow diagram of a method for establishing a dashboard interface for remote printer management, according to an implementation of the subject disclosure.

FIG. 8 is a schematic process flow diagram of a method for facilitating a remote modification of a printer, according to an implementation of the subject disclosure.

### DETAILED DESCRIPTION

In the following description, numerous specific details are set forth to provide a thorough understanding of the subject disclosure. One skilled in the relevant art will recognize, however, that the examples described herein can be practiced without one or more of the specific details, or with one or more other methods, components, materials, etc. In other instances, well-known structures, materials, or operations are not shown or described in detail to avoid obscuring certain aspects.

According to an aspect of the subject disclosure, described herein is a printing and print-management cloud computing service that allows a user to access a print dashboard from any access point using any browser or web-app capable interface. The dashboard can facilitate access to printer devices that designate the user as an authorized user.

From the print dashboard, the user can, based on associated access rights, access and use full printing functionality, view and edit settings, statuses (including errors, maintenance, and open jobs), processes, and other features of the printer devices. The user can have different access rights for different printers. For example, for a personal printer, the user can have administrator-level access rights allowing the user the privilege to view and edit all of settings, statuses, processes and the like. For a public printer, the user can have limited access rights with limited privileges, such as printing using a pre-determined set of settings, viewing open jobs, but not editing settings, statuses, processes, and the like.

When used herein, the term, “cloud computing application” refers generally to an application that is delivered as a centralized service from a centralized server to users and/or access points at remote locations through a browser or any other application that is able to display or manage a web-app. An “access point” may be any device with computing capability, generally including at least one memory and at least one processor. Examples of devices that can be used as an access point include: a desktop computer, a laptop computer, a tablet computer, a personal digital assistant, a smart phone, and the like. A browser can be any software application used by a computing device for accessing information (e.g., on the World Wide Web, on a private network through a server, etc.). Examples of browser programs include Firefox, Google Chrome, Internet Explorer, Opera, and Safari. A web-app is a hypertext markup language (HTML) application (e.g., a HTML5/JavaScript application) that nay be run in a window. For example, if an operating system's driver architecture allows a third party to use web-apps, the cloud management application can serve as a drive itself in any application running on the computing device.

If a printer is cloud-capable (e.g., can run a web-server and manage a web-app), then the whole cloud computing application can be served up on an intranet or local scale. Once a user connects to remote printers in addition to the cloud-capable printer, the cloud computing application is capable of managing both local and remote printers. The cloud-capable printer serves as an access point to the remote printers.

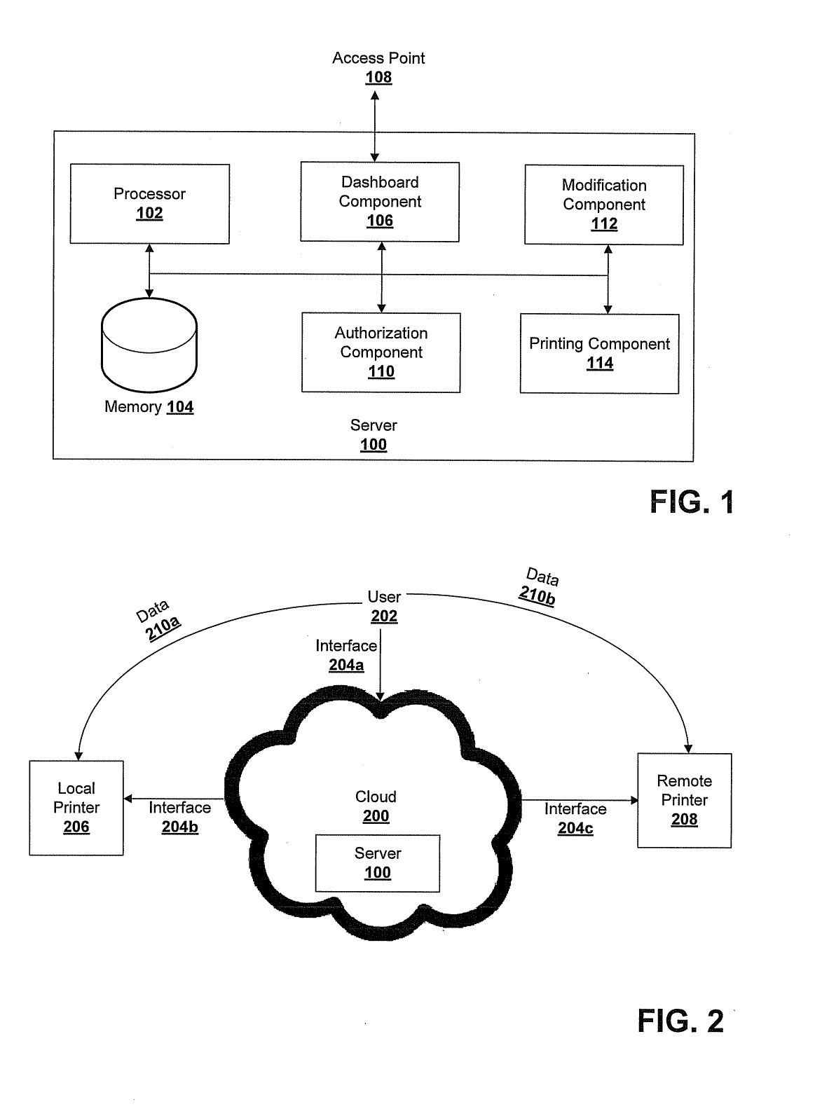

Referring now to FIG. 1 illustrated is a server 100 that facilitates remote printer management, according to an implementation of the subject disclosure. The server 100 can be a hardware device including at least one processor 102 and at least one memory 104. The at least one memory 104 can facilitate storage of computer-executable instructions, components, or the like. The at least one processor 102 can facilitate execution of at least one of the computer-executable instructions, components, or the like.

For example, remote printer management can be facilitated through a print management service. The at least one memory 104 can store computer-executable components that facilitate the print management service. The at least one processor 102 can facilitate execution of at least one component of the print management service. It will be understood that the components of the print management service can be housed on more than one server. A single server is illustrated merely for simplicity of illustration. The server can also be a device that is capable of serving the cloud computing application directly from a web-server capable printer itself.

The print management service includes a dashboard component 106. The dashboard component 106 acts as an interface between an access point 108 and/or a user at the print management service. The print management service has the functionality of a driver available via a web application.

The dashboard component 106 and the print management service facilitate management of a plurality of printers from an access point 108. The access point 108 can access the dashboard component through a public network or a private network.

The printers may be at different locations and may be private or public. An example of a private printer is a personal printer directly connected to the user's workstation. Examples of public printers include: commercial printers (made public by Print Service Providers), work printers, school printers, library printers, or the like.

The browser component 106 provides an interface between the access point 108 and one or more printers through a browser. The dashboard component 106 is platform-independent such that the browser component 106 provides a heterogeneous interaction in the sense of a variety of printers and a homogeneous interaction in the sense of consistent interaction between a user and the variety of printers. In other words, the dashboard component 106 appears substantially the same on any type of browser and behaves in substantially the same way for any type of browser. The dashboard component 106 may also be device independent, such that the dashboard component 106 appears in substantially the same form on any computing device and behaves in a substantially consistent and ubiquitous way for any type of computing device. Additionally, the dashboard component 106 operates in substantially the same way (at least at the level of the interface (UI/UX), not necessarily the full functionality) regardless of printer type (e.g., private, local, remote, public, and the like) and model.

The dashboard component 106 facilitates access to one or more printers from different access points. The one or more printers may be from the same manufacturer. However, the one or more printers may also be from different manufacturers. For example, the dashboard can display three printers: printer A from manufacturer A at location A, printer B from manufacturer A at location B, and printer C from manufacturer C, at location C. The dashboard component 106 can provide a consistent and ubiquitous interface to printers A, B and C regardless of their associated manufacturer and/or location.

The dashboard component 106 can receive identifying information from the access point 108 and/or the user. An authorization component 110 authorizes the access point 108 and/or the user the access one or more printers. The authorization component 110 may utilize the identifying information to make its authorization. The identifying information may include a user name and password. The user name and password can be linked to one or more authorized printers. The authorized printers may include a local printer, a remote printer or a combination of local printers or remote printers.

The authorization component 110 may locate different access rights for different printers. For example, the access point 108 or user may have administrator access rights for a personal printer, but limited access right for a public printer.

The dashboard component 106 displays authorized printers. A modification component 112 allows print-management functions according to the access rights. The modification component 112 may facilitate print-management functions, including viewing and editing settings, statuses, processes, or the like. A printing component 114 enables full printing capability on any printer connected via the dashboard component according to the access rights. Since the dashboard component 106 is universal for local and remote printers, files to print may be dragged and dropped from local to remote printers (assuming format compatibility).

Different access rights correspond to different print-management functions. As an example: a user with administrator-level access rights may have privileges including viewing and editing all of settings, statuses, processes, and submitting print-jobs with full control over settings, viewing a job-queue of all print jobs, while a user with limited access rights may have limited privileges, such as viewing open jobs, submitting print-jobs using a limited pre-determined set of printing settings, viewing progress of jobs submitted by the user alone, but not editing these settings, statuses, or processes.

Referring now to FIG. 2, illustrated system that facilitates remote printer management in a cloud computing environment 200, according to an implementation of the subject disclosure. The server 100 is centrally located within the cloud computing environment 200. The server 100 can be a local server (e.g., through a printer with cloud capabilities) or remote. The cloud computing environment 200 connects a user 202 to print devices, such as local printer 206 or remote printer 208, through an interface 204a, 204b, and 204c. The interface 204a, 204b, 204c may be provided by the dashboard component 106 of server 100.

The cloud computing environment 200 allows the user 202 to interact with print devices, such as local printer 206 and/or remote printer 208. The dashboard component 106 of server 100 facilitates interaction between the user 202 and the local printer 206 and the user 202 and the remote printer 208 in the same manner. A type of interaction is data exchange 210a, 210b between the user 202 and the printer device (local printer 206 or remote printer 208). The interaction can take place according to privileges associated with access rights of a user 202. Privileges of interaction are regulated through access component 110 according to access rights of the user to various print devices. The privileges of interaction can be different for each print device.

The cloud computing environment 200 acts as a gateway to the print devices (local printer 206 and remote printer 208). The cloud computing environment 200 can act as a direct entry point for managing printers (local printer 206 or remote printer 208). Printer management can be accomplished by the user 202 according to associated privileges. Printer management may include printing tasks, maintenance tasks, print job management tasks, and accounting tasks. Printer management may also include ordering supplies for the printer (local printer 206 or remote printer 208). The cloud computing environment 200 may provide a full fledged remote control mechanism that enables checking status (such as ink/paper/maintenance) and triggering various processes (such as calibration or profiling) from any access point 106 or user 202 via any browser. The cloud computing environment 200 may facilitate sharing of data between all connected printers 206, 208. For example, the cloud computing environment 200, through server 100, may provide a drop box of printers with drag and drop of print jobs.

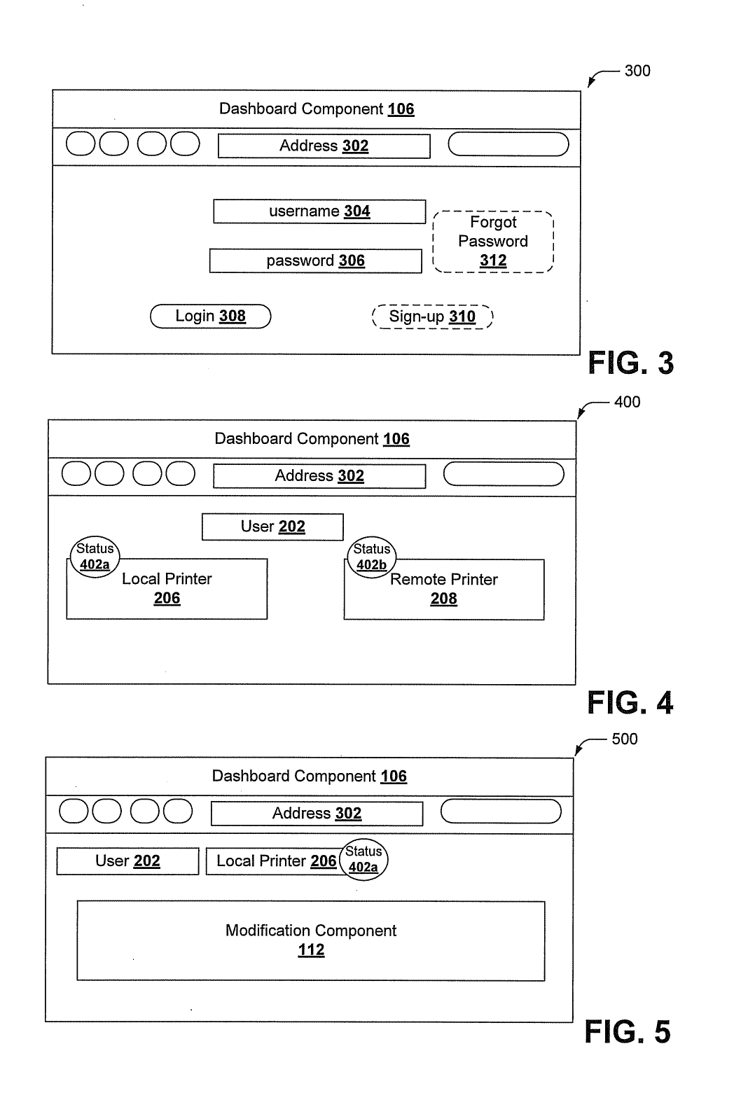

FIGS. 3-5 show example implementations of the dashboard component 106. The dashboard component 106 provides an interface 204a, 204b, 204c between an access point 108 and/or a user 202 and a plurality of printers (local printer 206 and remote printer 208). The dashboard component 106 may provide a graphical user interface that facilitates printing, print-management and control. The dashboard 106 interface is referred to herein as the “print management dashboard.”

Referring now to FIG. 3, illustrated, is an example login screen 300 of a print management dashboard of dashboard component 106, according to an implementation of the subject disclosure. The dashboard component 106 can be located at an address 302. The address 302 may be a web address. Credentials, such as a username 304 and password 306, can be entered into the log in screen 300. The credentials facilitate login 308 to a printer management screen, such as the printer management screen 400 of FIG. 4, that is specific to the user. The credentials may be utilized to link the user to associated printers and create printer management screen 400 of FIG. 4. The dashboard component 106 may also provide features for a user to sign-up 310 for access to associated printers or to recover lost credentials (such as a forgotten password 312).

Referring now to FIG. 4, illustrated is an example printer management screen 400 of the print management dashboard of dashboard component 106, according to an implementation of the subject disclosure. Upon validation of credentials, the user 202 can view both one or more local printers 206 and/or one or more remote printers 208. The dashboard component 106 can display the printers 206, 208 in a consistent, seamless fashion so that the displays for the different printers 206, 208 are substantially identical. According to access rights, the user 202 can view or edit statuses 402a, 402b of the printers 206, 208, submit print jobs to the printers 206, 208, manage print jobs of the printers 206, 208, etc.

The user 202 can further view the status 402a, 402b of the printers 206, 208 according to access rights for the printer associated with the user. Referring now to FIG. 5, illustrated is an example printer modification screen 600 of the print management dashboard of dashboard component 106, according to an implementation of the subject disclosure. The dashboard 106 can display the modification component 112 to facilitate modifications of the selected printer (here local printer 206). The modification component 112 may limit viewing and modification privileges for user 202 according to the associated access rights.

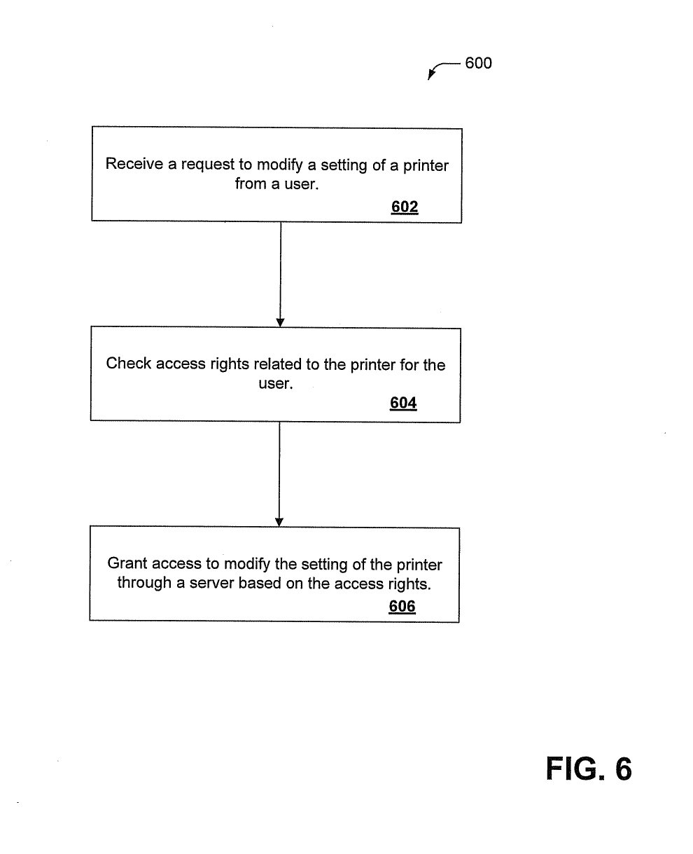

FIGS. 6-8 show methods illustrated as flow diagrams. For simplicity of explanation, the methods are depicted and described as series of acts. However, the methods are not limited by the acts illustrated and by the order of acts. For example, acts can occur in various orders and/or concurrently, and with other acts not presented and described herein. Furthermore, not all illustrated acts may be required to implement the methods. Additionally, it should be further appreciated that the methods can be implemented on an article of manufacture (e.g., a non-transitory computer-readable storage medium) to facilitate transporting and transferring the methods.

Referring now to FIG. 6, illustrated is a method 600 for remote printer management, according to an implementation of the subject disclosure. At element 602, a request to modify a setting of a printer is received from a user. The message is received at a central server, while the user is at a location remote from the central server. The request can be, through the user entering credentials, such as a user name and password, into a login screen on a browser.

Upon receiving the request, at element 604, access rights for the user related to the printer are checked. The access rights can be checked based on the credentials entered by the user. The access rights can define that the user has full rights for the printer, the user has limited rights for the printer, or the user has no rights for the printer. The user can have full rights for a printer where the user is an administrator, such as personal printer. The user can have limited rights for a printer in situations where the user does not have administrator rights. Examples of such printers include: public printers, commercial printers (e.g., exposed to be public by a Print Service Provider), library printers, office printers, school printers, or the like. The user can have no rights for a printer where the user is not authorized. The user may no longer be authorized to access an office printer for a job the user has quit. The user may also not be authorized to access a neighbor's personal printer.

After access rights have been established, at element 608, access can be granted to the printer according to the access rights. Once access is granted, the user can modify settings of the printer through the server based on the access rights for the specific printer. If the user has administrator level access rights, the user can modify any setting of the printer. If the user has limited access rights, the user can only modify some settings. For example, an administrator-level user can order supplies, change print quality, print files, etc., while a limited user can only print files.

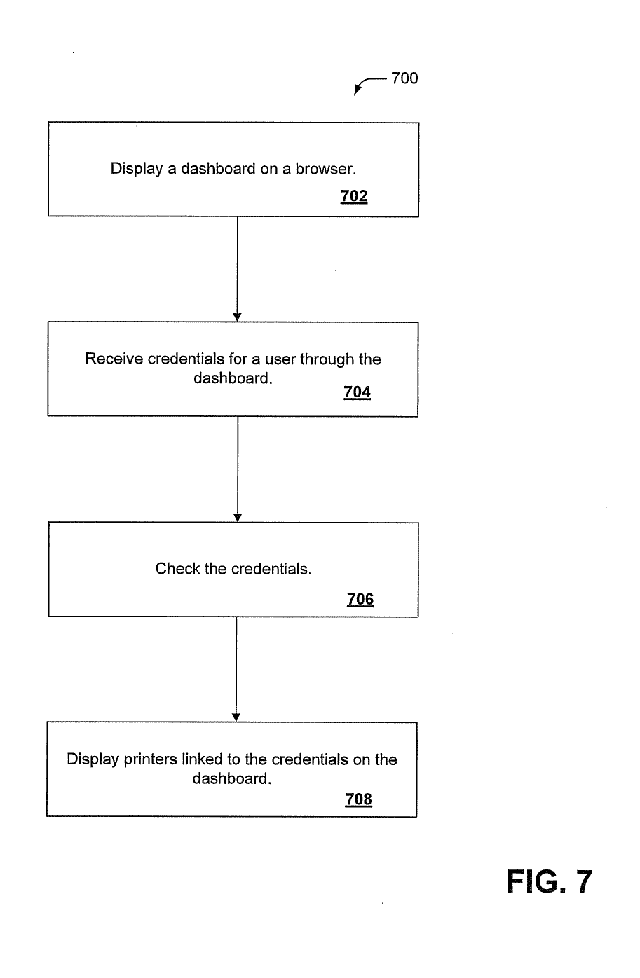

Referring now to FIG. 7, illustrated is a method 700 for establishing a dashboard interface for remote printer management, according to an implementation of the subject disclosure. At element 702, a dashboard is displayed on a browser. The dashboard is a platform-independent interface between a user and a server. In other words, the dashboard looks and/or behaves in substantially the same way whatever browser loads the dashboard. The dashboard facilitates management of one or more printers. From any moment and from any interface or device, a user can access the dashboard and view up-to-date information about the one or more printers. The information may include settings, device state, print jobs, and the like.

To facilitate printer management, at element 704, credentials are received for a user through the dashboard. The credentials allow printers for which the user has access rights to be displayed on the dashboard. At element 706, the credentials are checked. At 708, printers linked to the credentials are displayed on the dashboard. The dashboard can display any number of printers. According to an aspect, the dashboard can display at least one personal printer. In another aspect, the dashboard can display at least one public printer. In a further aspect, the dashboard can display at least one personal printer and at least one public printer. Further, in certain circumstances, the dashboard can display no printers if the access rights do not link the user with any printers. Printers displayed on the dashboard can be viewed using the browser or any other web-app displaying capable environment.

Through the dashboard, the user can view all of the printers for which the user has access rights. The user can modify settings of the printers for which the user has administrator level access rights. If the user has other non-administrator access rights, the user can make limited modifications. Different privileges to modify settings are available for different levels of access rights.

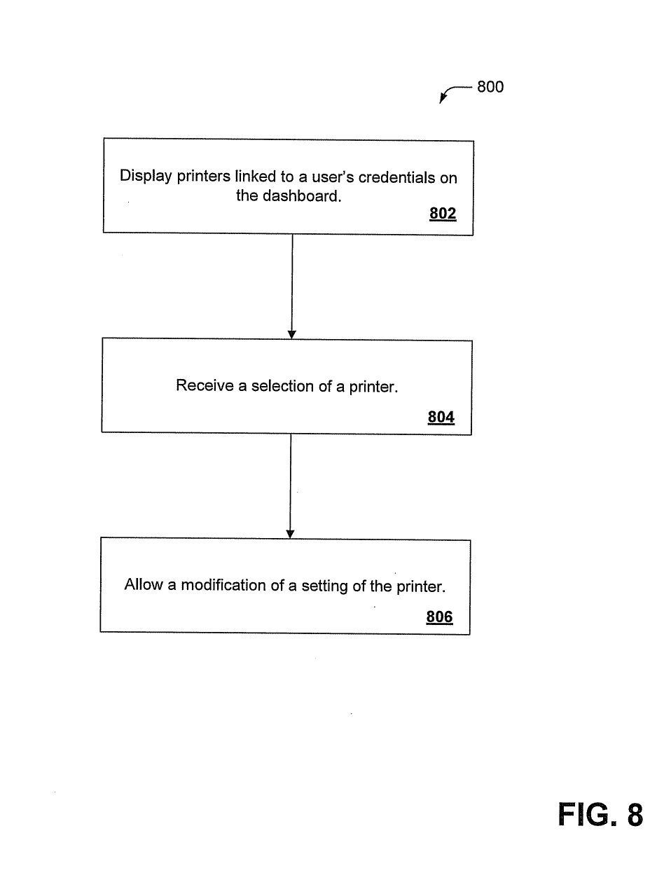

Referring now to FIG. 8, illustrated is a method 800 for establishing a dashboard interface for remote printer management, according to an implementation of the subject disclosure. At 802, printers linked to a user's credentials are displayed on a dashboard interface. At 804, a selection of one of the displayed printers is received. At 806, a modification of a setting of the selected printer is allowed based on privileges associated with the access rights.

The above description of illustrated embodiments, including what is described in the Abstract, is not intended to be exhaustive or to limit the disclosed implementations to the precise forms disclosed. While specific implementations and examples are described herein for illustrative purposes, various modifications are possible that are considered within the scope of such embodiments and examples, as those skilled in the relevant art can recognize.

As used herein, the word “example” is used to mean serving as an example, instance, or illustration. For the avoidance of doubt, the subject matter described herein is not limited by such examples. In addition, any aspect or design described herein as an “example” is not necessarily to be construed as preferred or advantageous over other aspects or designs, nor is it meant to preclude equivalent structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In this regard, while the subject matter has been described in connection with various implementations and corresponding Figures, where applicable, it is to be understood that other similar implementations can be used or modifications and additions can be made to the described implementations for performing the same, similar, alternative, or substitute function of the disclosed subject matter without deviating therefrom. Therefore, the disclosed subject matter should not be limited to any single implementation or example described herein, but rather should be construed in breadth and scope in accordance with the appended claims.

What is claimed is:

1. A system, comprising:
a memory storing computer-executable instructions;
a processor, communicatively coupled to the memory, that facilitates execution of the computer-executable instructions to at least:
receive a request for print or print-management from a user;
determine access rights of the user;
display a plurality of printers associated with the access rights; and
allow print or print-management for the plurality of printers according to the access rights.

2. The system of claim 1, wherein the request includes an access parameter for the user.

3. The system of claim 2, wherein the access rights are determined based on the access parameter for the user.

4. A server, comprising:
a memory storing computer-executable components;
a processor, communicatively coupled to the memory, that facilitates execution of a least one of the computer-executable components.
a dashboard component that facilitates control of a printer from an access point;
an authorization component that evaluates access rights to the printer; a printing component that enables full printing capability on any printer connected via the dashboard component; and
a modification component that changes a characteristic of the printer according to instructions from the access point according to the access rights.

5. The server of claim 4, wherein the dashboard component facilitates control of at least two printers from the access point.

6. The server of claim 4, wherein the server is the printer, wherein the printer is a local printer with web-capability.

7. The server of claim 4, wherein the modification component monitors the printer and alerts the access point when supplies are needed.

8. The server of claim 4, wherein the modification component monitors the printer and alerts the access point when attention is needed.

9. The server of claim 4, wherein authorization component facilitates tailoring of the dashboard component based on an evaluation of the access rights.

10. A method, comprising:
receiving a request to modify a setting of a printer from a user at a central server;
checking access rights related to the printer for the user; and
granting the user access to modify the setting of the printer or enabling full printing capability of the printer through the server based on the access rights related to the printer.

11. The method of claim 10, further comprising displaying a dashboard to facilitate printing capability.

12. The method of claim 11, wherein the displaying further comprises displaying the dashboard in a platform-independent manner.

13. The method of claim 10, wherein the displaying further comprises displaying the dashboard with at least two printers the user is authorized to access according to the access rights.

14. The method of claim 10, wherein the displaying further comprises displaying a dashboard with a personal printer for the user with corresponding privileges based on the access rights.

15. The method of claim 10, wherein the displaying further comprises displaying a dashboard with a public printer the user is authorized to access with corresponding privileges based on the access rights.
